(19) United States
(12) Patent Application Publication
(10) Pub. No.: US 2008/0298163 A1
(43) Pub. Date: Dec. 4, 2008

(54) Vibration Assisted Mixer

(76) Inventors: Jean-Louis Pessin, Houston, TX (US); Laurent Coquilleau, Houston, TX (US); Josh Rayner, Houston, TX (US); Michael Woodmansee, Houston, TX (US); Joel Rondeau, Antony (FR)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/117,831

(22) Filed: May 9, 2008

Related U.S. Application Data
(60) Provisional application No. 60/941,497, filed on Jun. 1, 2007.

(51) Int. Cl. B01F 11/00

(52) U.S. Cl. 366/114

(57) ABSTRACT

An embodiment of a mixer for mixing a powder with a liquid comprises a mix housing to accommodate a mixture of the powder and the liquid, a liquid delivery housing coupled to the mix housing to provide the liquid thereto, and a powder delivery housing coupled to the mix housing to provide the powder thereto, wherein the mixer is configured to induce a vibration therein for substantially avoid an occluding cake build-up of the mixture thereat.

### CROSS-REFERENCE TO RELATED APPLICATION

This application claims priority under 35 U.S.C. §119(e) to U.S. Provisional Application Ser. No. 60/941,497, entitled Vibration-Assisted Cement Mixer, filed on Jun. 1, 2007, which is incorporated herein by reference in its entirety.

### FIELD OF THE INVENTION

Embodiments described relate to mixers employed in the mixing of powders and liquids. In particular, embodiments of cement mixers are described for use in oilfield applications for cementing within a well.

### BACKGROUND OF THE RELATED ART

Combining powders and liquids to form a slurry mixture of the two is common practice in a variety of industries. From baking to the manufacture of molded parts, a whole host of industrial applications employ the use of a slurry mixture that is combined at one location and transported to another for further use. By way of example, cement slurry mixtures of liquid and powdered cement may be formed by combining the powder and the liquid within an industrial mixer. The industrial mixer may be in the form of a mobile cement truck which may be employed to deliver the cement slurry to a worksite for unloading and final use. Thus, in this manner, the slurry mixture is combined at one location and transported to another for final use and solidification.

Unlike the mobile cement truck example above, it may be preferable to have a more ready supply of cement slurry available at the worksite. For example, in the oilfield industry, cementing within a well may require a ready supply of large volumes of slurry. Furthermore, delivery of the slurry to the well may be required in a near continuous fashion. Thus, it may be more practical to form the cement slurry directly at the oilfield such that it may be immediately provided to the well and in a continuous manner to the extent required. This may be achieved through use of a cement mixer and other equipment that continuously mix and feed a supply of cement slurry to the well as described further below.

The above-noted cement mixer may be incorporated into a larger cementing assembly at the oilfield to achieve well cementing, such as, but not limited to, well construction, well remediation, well completion or the like, as will be appreciated by those skilled in the art. During well cementing, the availability of a constant supply of cement slurry from the cement mixer may play a crucial role in the operation. Furthermore, the overall amount of slurry and time required for the operation increases as the depth of the well increases. Thus, the amount of uptime required of the mixer may be substantially increased with the ever-increasing depth of hydrocarbon wells.

For the above-described operation, a variety of cement mixer configurations may be employed. For example, a batch mixing system with a central mix tank for receiving the cement powder and the liquid from separate locations may be employed. In this case, the mix tank serves as a mix location or ‘housing’ where the slurry is initially formed by the combination of the cement powder and liquid. Alternatively, the cement powder and liquid may be combined in a continuous manner. For example, a venturi or other mixer type may be employed where separate lines of liquid and cement powder are combined and simultaneously advanced down a common pathway toward the well or intervening circulation equipment. Regardless, a mix location is still found where the cement powder meets up with the liquid.

Unfortunately, irrespective of the particular mixer configuration, the cement powder and liquid may often combine outside of the intended mix location. When this occurs, a cake build-up (solids-dense non-flowing paste often referred to as “cake” or “cement cake”) of the slurry mixture may ensue in such a manner as to adversely affect the rate of slurry available from the mixer. For example, it is not uncommon for the liquid to splatter beyond the intended mix location and contact the line or housing which supplies the cement powder. When this occurs, cement powder that is directed toward the intended mix location may first encounter the splattered liquid and begin cake formation. Over time, this caking may lead to occlusion of the cement powder supply which may significantly hamper the efficiency of cementing and ultimately the entire well completion operation.

In the case of a cementing application at an oilfield, the above described cake build-up outside of the intended mix location may be dealt with in a variety of manners. For example, a decreasing rate of slurry available to the application may simply be tolerated until the occlusion reaches a level that no further slurry may be obtained from the mixer. At this time, or perhaps at some point prior, the cementing operation may be halted with the mixer and perhaps other surface equipment turned off. The mixer may then be replaced with another clean mixer pre-positioned at the oilfield or cleaned out and eventually placed back on line and the operation restarted. Regardless, in such circumstances, the efficiency of the entire well completion operation has been substantially affected by the reduced rate of available cement slurry and potential mixer downtime in order to address the issue.

### SUMMARY

An embodiment of a mixer for mixing a powder with a liquid comprises a mix housing to accommodate a mixture of the powder and the liquid, a liquid delivery housing coupled to the mix housing to provide the liquid thereto, and a powder delivery housing coupled to the mix housing to provide the powder thereto, wherein the mixer is configured to induce a vibration therein for substantially avoiding an occluding cake build-up of the mixture thereat. Alternatively, the powder is cement. Alternatively, the liquid is water. Alternatively, the liquid traverses the liquid delivery housing in jet form. Alternatively, the mixer is of a venturi configuration. Alternatively, the mixer further comprises a vibration mechanism coupled to the mixer for substantially avoid an occluding cake build-up of the mixture thereat. The vibration mechanism may be one of an impact vibrator, a piston vibrator, a rotating vibrator, a reed-type vibrator, and an ultrasonic vibrator.

In an alternative embodiment, a mixer for mixing a powder with a liquid comprises a mix location to accommodate a mixture of the powder and the liquid, a liquid delivery inlet coupled to the mix location to provide the liquid thereto, a powder delivery inlet coupled to the mix location to provide the powder thereto, and a vibration mechanism coupled to one of the mix location, the liquid delivery inlet, and the powder delivery inlet. Alternatively, the vibration mechanism is configured to impart vibrations for avoiding a substantially occluding cake build-up of the mixture in the mixer. The avoiding may be achieved by liquefying of the cake build-up. The liquefying may significantly increases a size of an opening of the powder delivery inlet to the mix inlet. Alternatively, at least one wall of one of the mix inlet, the liquid delivery inlet and the powder delivery inlet is constructed from one of metal, plastic, and a composite material. Alternatively, the vibration mechanism is configured to impart vibrations to promote mixing of the powder and liquid.

In an alternative embodiment, a vibration mechanism is coupled to a mixer for mixing a powder with a liquid in a mix housing of the mixer, the vibration mechanism configured for substantially eliminating an occluding cake build-up of the mixture outside of the mix housing. The vibration mechanism may be one of an impact vibrator, a piston vibrator, a rotating vibrator, a reed-type vibrator, and an ultrasonic vibrator. Alternatively, the eliminating occurs by liquefying of the cake build-up.

In an alternative embodiment, a method of forming a cement slurry at a mixer comprises providing water to a mix inlet of the mixer, adding cement powder to the mix inlet from a powder delivery inlet to form the cement slurry, and imparting a vibration to the mixer during the adding to substantially eliminate an occluding cake build-up of the slurry thereat. Alternatively, imparting comprises activating a vibration mechanism coupled to the mixer. Alternatively, activating operates during the providing and the adding in one of a continuous manner and intermittently for a pre-determined period. Alternatively, the mix inlet is coupled to an exit inlet leading to a well at an oilfield, the method further comprising cementing in the well with the cement slurry.

### BRIEF DESCRIPTION OF THE DRAWINGS

FIG. 1 is an overview of equipment at an oilfield employing an embodiment of a vibration assisted mixer.

FIG. 2 is an enlarged view of the vibration assisted mixer taken from 2-2 of FIG. 1.

FIG. 3A is a cross-sectional view of the vibration assisted mixer of FIG. 2 taken from 3-3 and revealing cake build-up therein.

FIG. 3B is a cross-sectional view of the vibration assisted mixer of FIG. 3A, revealing cake removal therefrom.

### DETAILED DESCRIPTION

Embodiments are described with reference to certain well completion operations at an oilfield. In particular, embodiments of cement mixers and equipment for cementing, such as, but not limited to, well construction, well remediation, well completion or the like, within a hydrocarbon well are described. However, a variety of mixers configured to combine a liquid and a powder at a mix location thereof may be well suited for use with embodiments of a vibration mechanism as described herein. For example, mixers employed outside of an oilfield environment or for applications other than cement slurry formation may take advantage of embodiments of vibration mechanisms as detailed herein. Nevertheless, cement mixers for use in oilfield operations may be particularly suited for use with such vibration mechanisms as detailed below.

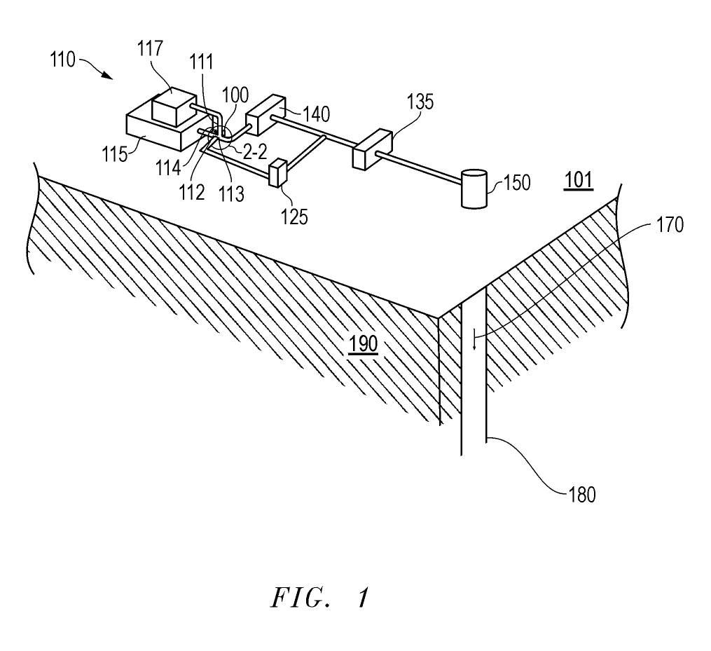

Referring now to FIG. 1, an embodiment of a mixer location or assembly 110 is depicted at an oilfield 101 along with other surface equipment for cementing of a well 180. The mixer assembly 110 includes a cement mixer 114, where separate lines of cement powder and liquid intersect at a mix housing or mix location 113 to form a cement slurry 170. The slurry 170 may be delivered downhole to the well 180. Additionally, the cement mixer 114 may include a vibration mechanism 100 coupled or otherwise operatively connected to the cement powder delivery inlet or housing 111 so as to substantially avoid the build-up of cement cake within the housing 111. As detailed further below, this may help to avoid the occlusion of the cement delivery housing or powder inlet 111, thereby enhancing the efficiency of the cementing portion of a well cementing operation.

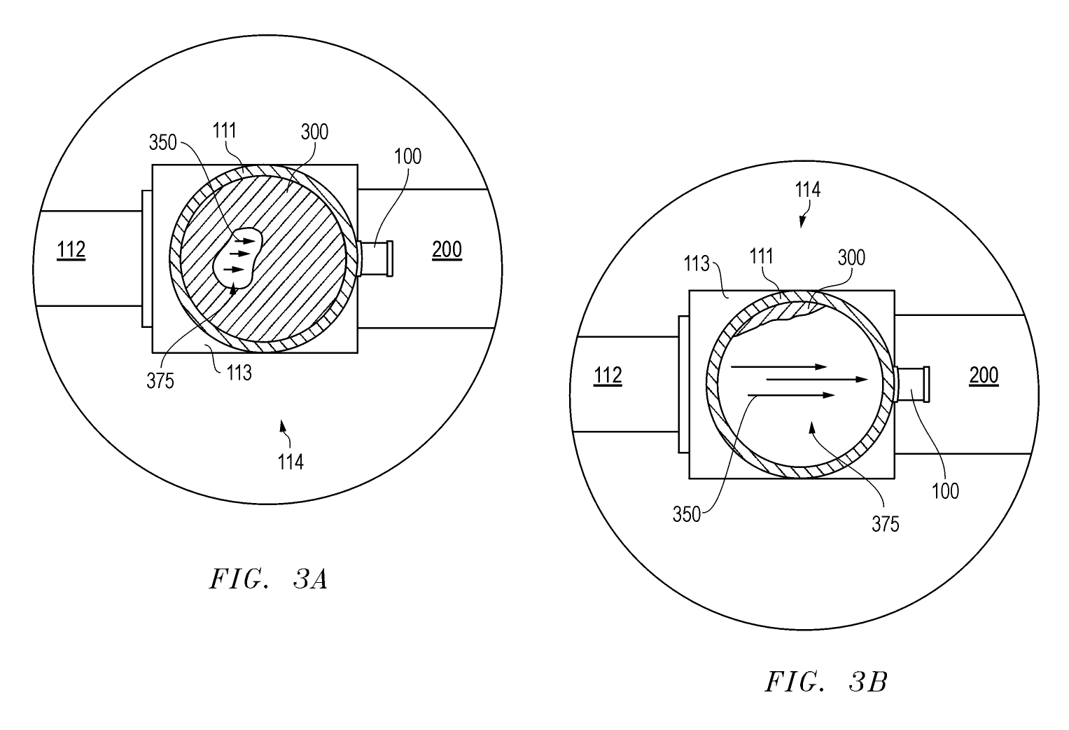

Continuing with reference to FIG. 1, the mixer assembly 110 is depicted with a cement powder supply 117 positioned adjacent a water jet supply 115. The cement powder supply 117 may be pressurized and/or configured for gravity feeding cement powder to the delivery housing 111. Thus, the cement powder may drop to the mix location 113. Accordingly, the water jet supply 115 may be configured to dispense a water jet 350 (best seen in FIGS. 3A and 3B) through a liquid delivery inlet or housing 112. As such, the water jet 350 may be directed to the mix location 113 where it may combine with the delivered cement powder (see FIGS. 3A and 3B). Thus, an at least partially mixed slurry 170 of the powder and water may be driven through an exit pipe 200 toward a manifold 140 for later delivery to the well 180 as detailed further below. While the mixed slurry 170 is described as a mixture of water and cement powder, other constituents may be provided. For example, additives may be provided with the dry cement powder or the water. Additionally, other liquids may be employed in place of, or in conjunction with the water.

The mixer assembly 110 may further comprise at least one positive displacement pump 135 that directs cement slurry 170 from a slurry holding tank or mix tub 140, through a well head 150 and into the well 180 that penetrates a formation layer 190. The mix tub 140 may include a recirculating pump 125 in fluid communication with the mix tub 140 and the mixing location 113. Adequate pressure, of up to 15,000 PSI or more, for driving the cement slurry 170 may be provided by the pump 135.

As noted, the overall efficiency of the above described well cementing operation may be dependent in large part on the availability of a near constant supply of cement slurry 170 from the mixer assembly 110. Thus, as indicated above, the cement mixer 114 of the assembly 110 is equipped with a vibration mechanism 100 so as to substantially reduce the build-up of cement cake within the cement delivery housing or inlet 111. As such, occlusion of the housing 111 may be avoided so as to help optimize the uptime of the mixer 114 during well cementing operation.

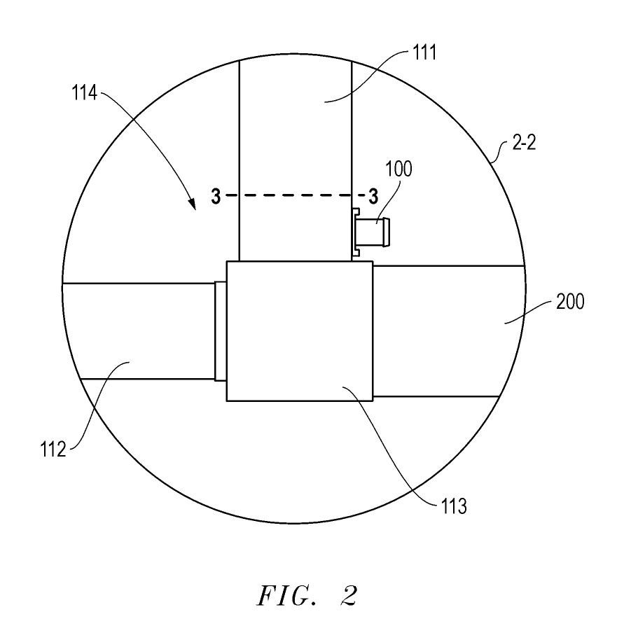

Referring now to FIG. 2, with added reference to FIGS. 1, 3A, and 3B, an enlarged view of the cement mixer or liquid and powder interface 114 is shown. The mixer 114 is of a venturi configuration with the liquid delivery inlet or housing 112 carrying a water jet 350 below the cement delivery housing or inlet 111. As alluded to above, cement powder may thus be drawn from the housing 111 toward the mix location 113. The force of the water jet 350 may then drive the newly forming cement slurry 170 out an exit housing or outlet 200 toward the slurry holding or mix tub 140 of FIG. 1 for subsequent downstream use. In the embodiment shown, the water jet 350 is of a horizontal variety. However, in other embodiments, the water jet 350 may be of a vertical or inclined configuration. Additionally, as detailed further below, the mixer 114 itself may be of a non-venturi configuration altogether.

FIG. 2 also reveals the above noted vibration mechanism 100. With added reference to FIGS. 3A and 3B, the vibration mechanism 100 is coupled directly to the cement delivery housing 111 in the embodiment shown. In this manner, the vibration mechanism 100 may be employed to impart vibration through the housing 111 to help prevent or remove cake build-up 300 thereat. That is, unlike other portions of the mixer 114 outside of the mix location 113, the cement delivery housing 111 may be particularly prone to the effects of cake build-up 300. That is, a water jet 350 may be driven through the liquid delivery housing 112, the mix location 113, and the exit housing 200 as described above. As such, cake build-up 300 in these locations 112, 113, 200, may be substantially avoided or eliminated by the water jet 350. The cement delivery housing 111 on the other hand, lacks the inherent clean out benefit of a water jet 350 intentionally driven therethrough. Therefore, as detailed further below, positioning of the vibration mechanism 100 directly at the housing 111 may be particularly advantageous.

Continuing now with reference to FIGS. 3A and 3B, top cross-sectional views of the vibration assisted cement mixer 114 taken from 3-3 of FIG. 2 are depicted. Specifically, FIG. 3A reveals the mixer 114 with an accumulation of cake build-up 300 within the cement delivery housing 111. However, as depicted in FIG. 3B, vibrations from the vibration mechanism 100 may be employed to substantially liquefy the build-up 300. As such, the size of the opening 375 through which cement powder may be dropped into the mix location 113 may be increased.

Continuing with reference to FIG. 3A, the build-up 300 may be a result of water splattering to the internal surface of the housing or inlet 111 from the water jet 350 below. Moisture on the internal surface of the housing or inlet 111 may thus, mix with cement powder outside of the intended mix location 113. As a result, the cake build-up 300 may ensue within the cement delivery housing 111. In the embodiment shown, the build-up 300 is to a degree substantially occluding the housing 111, leaving the opening 375 through which the cement powder may be dropped or otherwise introduced into the mix location 113 of minimal size.

As indicated above, the vibration mechanism 100 may be employed to substantially remove the depicted cake build-up 300 as depicted in FIG. 3B. For example, in one non-limiting embodiment, the inner diameter of the cement delivery housing 111 may be between about 3 and about 5 inches. Thus, complete occlusion of such a housing 111 with an average of about an inch of cake build-up 300 there-across would represent a volume of between about 9.4 and about 15.7 cubic inches of build-up 300. Of course, without preventative or evasive action, the volume of cake build-up 300 may rise even further, backing up the cement delivery housing or inlet 111 with the build-up 300.

In order to ensure a constant supply of slurry 170 for an operation as depicted in FIG. 1, the vibration mechanism 100 may be employed to liquefy the build-up 300 in advance of reaching such degrees of complete occlusion. Thus, as shown in FIG. 3A, in the face of a shrinking opening 375, the vibration mechanism 100 is employed to substantially liquefy the build-up 300 to significantly increase the size of the opening 375. For example, in one embodiment, the vibration mechanism 100 may be a conventional impact vibrator mounted to a housing 111 having a thickness of between about 0.0625 and about 2.0 inches. The housing 111 may be of a metal, plastic, composite, or other conventional material. As such, the vibration mechanism 100 may be configured to impart between about 5 and about 3,000 lbf. at frequencies of between about 1 Hz and about 20 kHz in order to substantially liquefy the cake build-up 300 as depicted in FIG. 3B.

Continuing with reference to FIGS. 3A and 3B, in addition to an impact vibrator, the vibration mechanism 100 may be a piston vibrator, a rotating vibrator, a reed-type vibrator, an ultrasonic piezoelectric vibrator, or other vibrator type, as will be appreciated by those skilled in the art. Additionally, as described above, the vibration mechanism 100 may be employed to substantially eliminate cake build-up 300 within the cement delivery inlet 111. However, in other embodiments, the vibration mechanism 100 may be employed to substantially avoid cake build-up 300. That is, as opposed to activation of the vibration mechanism 100 in the face off cake build-up 300, the vibration mechanism 100 may remain active continuously throughout the use of the mixer 114 so as to avoid cake build-up 300. Alternatively, the vibration mechanism 100 may be activated intermittently for predetermined periods during use of the mixer 114 in order to avoid cake build-up 300.

In addition to the embodiments of FIGS. 3A and 3B, the vibration mechanism 100 may be mounted at structural locations of the mixer 114 apart from the cement delivery housing 111. For example, as a matter of design choice, the vibration mechanism 100 may be mounted to the housing of the mix location 113 or other structural portion of the mixer 114 which is adequately coupled or otherwise operatively connected to the cement delivery housing 111 so as to impart vibrations from the mechanism 100 thereto, as will be appreciated by those skilled in the art. Additionally, in alternative mixer configurations other regions of the mixer 114 more prone to cake build-up 300 may be present whereat the vibration mechanism 100 may be mounted. Alternatively, the vibration mechanism 100 may be removably mounted to any of the components of the mixer 114.

As indicated above, alternative mixer configurations may be employed in conjunction with a vibration mechanism 100 wherein a liquid and a powdered material are introduced at a common location to prevent cake buildup of the powdered material including, but not limited to, systems wherein the powdered material is introduced into a mixing location via directional ports, wherein the powdered material is introduced into an axial liquid stream, wherein the powdered material is drawn into a mixing bowl via a recirculated slurry venturi, wherein the powdered material is tangentially introduced into an axial stream of liquid, wherein perpendicular streams of powdered material and liquid are introduced into a mixing location, wherein powdered material is mechanically introduced to a mixing location, and wherein a liquid and powder are introduced at distinct locations in a mixing tub in a batch mixing process, as will be appreciated by those skilled in the art.

Embodiments described hereinabove include a mixer that may be employed to provide a cement slurry to a well cementing operation at an oilfield on a substantially continuous basis. This may be achieved by the substantial elimination or avoidance of cement cake build-up within the mixer during the operation. Furthermore, these embodiments provide slurry in a manner that avoids any significant decrease in the rate of slurry available to the operation. Thus, the efficiency of the overall well cementing operation may not be subject to or hampered by the rate of available cement slurry therefor.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, the vibration mechanism has been described and depicted as a discrete mechanism mounted to the mixer. However, in alternate embodiments, the vibration mechanism may be integrally incorporated into the housing or body of the mixer itself Additionally, the vibration mechanism may be one which induces the liquid supply to generate vibration in the mixer, for example, by way of throttling the liquid flow across a valve or orifice or in the form of a reed positioned in the flow path. Furthermore, the foregoing description should not be read as pertaining only to the precise structures described and shown in the accompanying drawings, but rather should be read as consistent with and as support for the following claims, which are to have their fullest and fairest scope.

We claim:

1. A mixer for mixing a powder with a liquid, the mixer comprising:
a mix housing to accommodate a mixture of the powder and the liquid;
a liquid delivery housing coupled to the mix housing to provide the liquid thereto; and
a powder delivery housing coupled to the mix housing to provide the powder thereto, wherein the mixer is configured to induce a vibration therein for substantially avoiding an occluding cake build-up of the mixture thereat.

2. The mixer of claim 1 wherein the powder is cement.

3. The mixer of claim 1 wherein the liquid is water.

4. The mixer of claim 1 wherein the liquid traverses the liquid delivery housing in jet form.

5. The mixer of claim 4 being of a venturi configuration.

6. The mixer of claim 1 further comprising a vibration mechanism coupled to the mixer for substantially avoid an occluding cake build-up of the mixture thereat.

7. The mixer of claim 6 wherein the vibration mechanism is one of an impact vibrator, a piston vibrator, a rotating vibrator, a reed-type vibrator, and an ultrasonic vibrator.

8. A mixer for mixing a powder with a liquid, the mixer comprising:
a mix location to accommodate a mixture of the powder and the liquid;
a liquid delivery inlet coupled to the mix location to provide the liquid thereto;
a powder delivery inlet coupled to the mix location to provide the powder thereto; and
a vibration mechanism coupled to one of the mix location, the liquid delivery inlet, and the powder delivery inlet.

9. The mixer of claim 8 wherein the vibration mechanism is configured to impart vibrations for avoiding a substantially occluding cake build-up of the mixture in the mixer.

10. The mixer of claim 9 wherein the avoiding is achieved by liquefying of the cake build-up.

11. The mixer of claim 10 wherein the liquefying significantly increases a size of an opening of the powder delivery inlet to the mix inlet.

12. The mixer of claim 10 wherein at least one wall of one of the mix inlet, the liquid delivery inlet and the powder delivery inlet is constructed from one of metal, plastic, and a composite material.

13. The mixer of claim 8 wherein the vibration mechanism is configured to impart vibrations to promote mixing of the powder and liquid.

14. A vibration mechanism coupled to a mixer for mixing a powder with a liquid in a mix housing of the mixer, the vibration mechanism configured for substantially eliminating an occluding cake build-up of the mixture outside of the mix housing.

15. The vibration mechanism of claim 14 being one of an impact vibrator, a piston vibrator, a rotating vibrator, a reed-type vibrator, and an ultrasonic vibrator.

16. The vibration mechanism of claim 14 wherein the eliminating occurs by liquefying of the cake build-up.

17. A method of forming a cement slurry at a mixer, the method comprising:
providing water to a mix inlet of the mixer;
adding cement powder to the mix inlet from a powder delivery inlet to form the cement slurry; and
imparting a vibration to the mixer during the adding to substantially eliminate an occluding cake build-up of the slurry thereat.

18. The method of claim 17 wherein imparting comprises activating a vibration mechanism coupled to the mixer.

19. The method of claim 17 wherein the activating operates during the providing and the adding in one of a continuous manner and intermittently for a pre-determined period.

20. The method of claim 17 wherein the mix inlet is coupled to an exit inlet leading to a well at an oilfield, the method further comprising cementing in the well with the cement slurry.
